(19) United States
(12) Patent Application Publication
(10) Pub. No.: US 2022/0344662 A1
(43) Pub. Date: Oct. 27, 2022

(54) LEAD-ACID BATTERY

(71) Applicant: GS Yuasa International Ltd., Kyoto-shi, Kyoto (JP)

(72) Inventors: Ryotaro WAMA, Kyoto (JP); Akihito TSUJINAKA, Kyoto (JP)

(21) Appl. No.: 17/762,624

(22) PCT Filed: Sep. 24, 2020
(86) PCT No.: PCT/JP2020/035914

§ 371 Date: Mar. 22, 2022

(30) Foreign Application Priority Data
Sep. 27, 2019 (JP) 2019-178095

(51) Int. Cl. H01M 4/62; H01M 4/14; H01M 4/583

(52) U.S. Cl. CPC H01M 4/62; H01M 4/14; H01M 4/583; H01M 2004/027

(57) ABSTRACT

A lead-acid battery includes a positive electrode plate, a negative electrode plate, and an electrolyte solution. The negative electrode plate includes a negative electrode material. The negative electrode material contains an organic expander and carbonaceous material. The organic expander contains a unit of a bisarene compound and a unit of a monocyclic aromatic compound having a hydroxy group. The unit of a bisarene compound is at least one selected from the group consisting of a unit of a bisphenol S compound and a unit of a bisphenol A compound.

### TECHNICAL FIELD

The present invention relates to a lead-acid battery.

### BACKGROUND ART

Lead-acid batteries are in use for various applications, including automotive and industrial applications. A lead-acid battery includes a negative electrode plate, a positive electrode plate, and an electrolyte solution. The negative electrode plate includes a current collector and a negative electrode material. An organic expander is added to the negative electrode material. As the organic expander, naturally derived organic expanders such as sodium lignin sulfonate, and synthetic organic expanders are used. Examples of the synthetic organic expander include condensates of bisphenols.

Patent Document 1 discloses a lead-acid battery including a positive electrode, a negative electrode and an electrolyte solution, the negative electrode including a negative electrode material and a negative current collector, the negative electrode material containing a bisphenol-based resin and a negative active material, the negative current collector including a lug, the lug being provided with a surface layer of Sn or a Sn alloy.

Patent Document 2 discloses a flooded-type lead-acid battery including a negative active material containing spongy lead as a main component, a positive active material containing lead dioxide as a main component, and a flowable electrolyte solution containing sulfuric acid, the negative active material containing carbon, at least one substance selected from the group consisting of cellulose ether, a polycarboxylic acid and salts thereof, and a water-soluble polymer including a bisphenol-based condensate having a sulfonic acid group, the positive active material contains antimony.

Patent Document 3 discloses a flooded-type lead-acid battery including a negative active material containing spongy lead as a main component, a positive active material containing lead dioxide as a main component, and a flowable electrolyte solution containing sulfuric acid, the negative active material containing carbon black at 0.5 mass % or more and 2.5 mass % or less per 100 mass % of spongy lead in a formed state, a water-soluble polymer including a bisphenol-based condensate having a sulfonic acid group as a substituent, and at least one polycarboxylic acid compound selected from the group consisting of polyacrylic acid, polymethacrylic acid, polymaleic acid and salts thereof, the electrolyte solution having a carbon black concentration of 3 mass ppm or less in a formed state.

Patent Document 4 discloses a negative electrode plate for a lead-acid battery which includes a negative active material containing spongy lead as a main component, and a current collector, the negative active material containing carbon black at 1.0 mass % or more and 2.5 mass % or less and a bisphenol condensate at 0.1 mass % or more and 0.9 mass % or less per 100 mass % of spongy lead, and having a median pore size of 0.5 μm or less on a volume basis and a porosity of 0.22 mL/g or more and 0.4 mL/g or less, in a formed stage.

Patent Document 5 discloses a valve regulated lead-acid battery including a positive electrode plate, a negative electrode plate and an electrolyte solution, in which the negative electrode plate includes a negative current collector and a negative electrode material, the density of the negative electrode material is more than 2.6 g/cm³, the negative electrode material contains an organic expander, and the content of sulfur element in the organic expander is more than 600 μmol/g.

### PRIOR ART DOCUMENTS

### Patent Documents

Patent Document 1: JP-A-2017-79166
Patent Document 2: WO 2013/150754 A
Patent Document 3: JP-A-2013-161606
Patent Document 4: JP-A-2014-123525
Patent Document 5: JP-A-2018-18742

### SUMMARY OF THE INVENTION

### Problems to be Solved by the Invention

If a negative electrode material contains a carbonaceous material, the carbonaceous material flows out to an electrolyte solution. The outflow of the carbonaceous material becomes more marked as the content of the carbonaceous material in the negative electrode material increases.

### Means for Solving the Problems

One aspect of the present invention relates to a lead-acid battery including a positive electrode plate, a negative electrode plate and an electrolyte solution, in which

the negative electrode plate contains a negative electrode material,

the negative electrode material contains an organic expander and a carbonaceous material,

the organic expander contains a unit of a bisarene compound and a unit of a monocyclic aromatic compound having a hydroxy group, and

the unit of a bisarene compound is at least one selected from the group consisting of a unit of a bisphenol S compound and a unit of a bisphenol A compound.

### Advantages of the Invention

In a lead-acid battery, outflow of a carbonaceous material from a negative electrode material can be suppressed.

### BRIEF DESCRIPTION OF THE DRAWINGS

FIG. 1 is a partially cutaway exploded perspective view showing an appearance and an internal structure of a lead-acid battery according to one aspect of the present invention.

### MODE FOR CARRYING OUT THE INVENTION

A lead-acid battery according to one aspect of the present invention includes a positive electrode plate, a negative electrode plate, and an electrolyte solution. The negative electrode plate contains a negative electrode material. The negative electrode material contains an organic expander and carbonaceous material. The organic expander contains a unit of a bisarene compound and a unit of a monocyclic aromatic compound having a hydroxy group. The unit of a bisarene compound is at least one selected from the group consisting of a unit of a bisphenol S compound and a unit of a bisphenol A compound. Hereinafter, the monocyclic aromatic compound having a hydroxy group is sometimes referred to as a hydroxy monoarene compound.

The above-described configuration suppresses outflow of a carbonaceous material from a negative electrode material to an electrolyte solution. Since the organic expander contains a unit of a hydroxy monoarene compound and a unit of a bisarene compound, a high expanding effect of the expander can be maintained. The unit of a hydroxy monoarene compound facilitates formation of a planar structure, and enhances the flexibility of organic expander molecules. The organic expander typically contains many functional groups having negative polarity, and it is considered that the functional groups having negative polarity are likely to be concentrated on the surfaces of the molecules when the flexibility of the molecules is enhanced. Due to the planar structure and the presence of functional group having negative polarity and concentrated on the surfaces, the organic expander is easily adsorbed to components (e.g. lead, lead sulfate and a carbonaceous material) contained in the negative electrode material. The organic expander adsorbed to the component in the negative electrode material is modified in an electrolyte solution to exhibit a function like that of a binding material. Outflow of the carbonaceous material may be suppressed by such a binding action of the organic expander. On the other hand, lignin has a three-dimensionally developed polymer structure. Thus, lignin has a smaller binding action on the components contained in the negative electrode material than the above-described organic expander, and it may be difficult to obtain the effect of suppressing outflow of the carbonaceous material even when the content of lignin is increased.

The lead-acid battery may be a valve regulated (sealed) lead-acid battery, and is particularly useful as a flooded-type (vented type) lead-acid battery in which outflow of a carbonaceous material is likely to be a problem.

Hereinafter, the lead-acid battery according to an embodiment of the present invention will be described for each of the main constituent elements, but the present invention is not limited to the following embodiment.

### [Lead-Acid Battery]

### (Negative Electrode Plate)

The negative electrode plate usually includes a negative current collector in addition to a negative electrode material. The negative electrode material is a portion obtained by removing the negative current collector from the negative electrode plate. Note that a member such as a mat or a pasting paper may be stuck to the negative electrode plate. Such a member (sticking member) is used integrally with the negative electrode plate and is thus assumed to be included in the negative electrode plate. Also, when the negative electrode plate includes such a member, the negative electrode material is a portion obtained by removing the negative current collector and the sticking member from the negative electrode plate. However, when the sticking member (e.g. mat or pasting paper) is attached to a separator, a thickness of the sticking member is included in a thickness of the separator.

The negative current collector may be formed by casting lead (Pb) or a lead alloy, or may be formed by processing a lead sheet or a lead alloy sheet. Examples of the processing method include expanding processing and punching processing. It is preferable to use a grid-like current collector as the negative current collector because the negative electrode material is easily supported.

The lead alloy used for the negative current collector may be any of a Pb—Sb-based alloy, a Pb—Ca-based alloy, and a Pb—Ca—Sn-based alloy. The lead or lead alloys may further contain, as an additive element, at least one selected from the group consisting of Ba, Ag, Al, Bi, As, Se, Cu, and the like. The negative current collector may include a surface layer. The surface layer and the inner layer of the negative current collector may have different compositions. The surface layer may be formed in a part of the negative current collector. The surface layer may be formed in the lug of the negative current collector. The surface layer of the lug may contain Sn or a Sn alloy.

The negative electrode material contains an organic expander containing the unit of a bisarene compound and the unit of a hydroxy monoarene (hereinafter, sometimes referred to as a first organic expander), and a carbonaceous material. Typically, the negative electrode material further contains a negative active material (lead or lead sulfate) that exhibits a capacity through a reduction reaction. The negative electrode material may contain at least one selected from the group consisting of other organic expanders (hereinafter, sometimes referred to as a second organic expander), and other additives. Examples of the additive include barium sulfate, fibers (resin fibers and the like), and the like, but are not limited thereto. Note that the negative active material in a charged state is spongy lead, and the non-formed negative electrode plate is typically prepared using lead powder.

### (Organic Expander)

The negative electrode material contains an organic expander. The organic expander refers to an organic compound among compounds having a function of suppressing shrinkage of lead as a negative active material when charge-discharge of the lead-acid battery is repeated. As described above, the negative electrode material contains as an essential component the first organic expander among organic expanders, and may further contain the second organic expander if necessary. The first organic expander is an organic expander containing at least one bisarene compound unit selected from the group consisting of a unit of a bisphenol S compound and a unit of a bisphenol A compound, and a unit of a monocyclic aromatic compound having a hydroxy group (hydroxy monoarene compound). The second organic expander is an organic expander other than the first organic expander. As the organic expander, an organic expander synthesized by a known method may be used, or a commercially available product may be used.

Examples of the organic expanders include synthetic organic expanders. The synthetic organic expander used in lead-acid batteries is typically an organic condensate (hereinafter, referred to simply as a condensate). The condensate is a synthetic substance that can be obtained using a condensation reaction. Lignin is a natural material, and is therefore excluded from condensates (synthetic organic expanders) which are synthetic substances. The condensate may contain a unit of an aromatic compound (hereinafter, also referred to as an aromatic compound unit). The aromatic compound unit refers to a unit derived from an aromatic compound incorporated in a condensate. That is, the aromatic compound unit is a residue of an aromatic compound. The condensate may contain one or more aromatic compound units.

Examples of the condensate include condensates of aromatic compounds with aldehyde compounds. Such a condensate can be synthesized by reacting an aromatic compound with an aldehyde compound. Here, a condensate containing a sulfur element can be obtained by carrying out a reaction between an aromatic compound and an aldehyde compound in the presence of a sulfite or using an aromatic compound (e.g. bisphenol S) containing a sulfur element as an aromatic compound. For example, the sulfur element content in the condensate can be adjusted by adjusting at least one of the amount of the sulfite and/or the amount of the aromatic compound containing a sulfur element. Even when other raw materials are used, this method may be followed. One or more aromatic compounds may be condensed for obtaining the condensate. The aldehyde compound may be an aldehyde (e.g. formaldehyde), a condensate (or polymer) of an aldehyde, or the like. Examples of the aldehyde condensate (or polymer) include paraformaldehyde, trioxane and tetraoxymethylene. One of the aldehyde compounds may be used alone, or two or more thereof may be used in combination. Formaldehyde is preferable from the viewpoint of having high reactivity with an aromatic compound.

The aromatic compound may further have a sulfur-containing group. That is, the condensate may be an organic polymer containing a plurality of aromatic rings in the molecule and containing a sulfur element as a sulfur-containing group. The sulfur-containing group may be directly bonded to the aromatic ring of the aromatic compound, and for example, may be bonded to the aromatic ring as an alkyl chain having a sulfur-containing group. Among the sulfur-containing groups, a sulfonic acid group or a sulfonyl group which is in a stable form is preferable. The sulfonic acid group may exist in an acid form, or may exist in a salt form like a Na salt.

The sulfur-containing group is a functional group having strong negative polarity. Since such a functional group forms a stable bond with water molecules, hydrogen ions and hydrogen sulfate ions in the electrolyte solution, functional groups tend to be concentrated on the surface of the condensate. Since such functional groups concentrated on the surface have a negative charge, electrostatic repulsion occurs between associates of the condensate. This restricts association or aggregation of colloidal particles of the condensate, so that the colloidal particle size is likely to decrease. It is considered that as a result, the negative electrode material has a small pore size, and the specific resistance of the negative electrode material is likely to decrease. Thus, when a condensate having a sulfur-containing group is used, a further high expanding effect can be secured, so that it is easy to obtain excellent low-temperature HR discharge performance and charge acceptability.

Examples of the aromatic ring of the aromatic compound include a benzene ring, a naphthalene ring, and the like. When the aromatic compound has a plurality of aromatic rings, the plurality of aromatic rings may be linked by a direct bond, a linking group (e.g. an alkylene group (including an alkylidene group), and a sulfone group), or the like. Examples of such a structure include bisarene structures (biphenyl, bisphenylalkane, bisphenylsulfone, and the like).

Examples of the aromatic compound include compounds having the aromatic ring and a functional group (e.g. hydroxy group or amino group). The functional group may be directly bonded to the aromatic ring, or may be bonded as an alkyl chain having a functional group. Note that the hydroxy group also includes salts of hydroxy group (—OMe). The amino group also includes salts of amino group (salts with anion). Examples of Me include alkali metals (Li, K, Na, and the like), Group 2 metals of the periodic table (Ca, Mg, and the like), and the like. The aromatic group may have a substituent other than a sulfur-containing group and the above-described functional groups (e.g. an alkyl group or an alkoxy group) on the aromatic ring.

The aromatic compound as a base of the aromatic compound unit may be at least one selected from the group consisting of a bisarene compound and a monocyclic aromatic compound.

Examples of the bisarene compound include bisarene compounds having a hydroxy group (e.g. bisphenol compounds and hydroxybiphenyl compounds), and bisarene compounds having an amino group (bisarylalkane compounds having an amino group, bisarylsulfone compounds having an amino group, and biphenyl compounds having amino group). Among them, bisarene compounds having a hydroxy group (particularly, bisphenol compounds) are preferable.

As the bisphenol compound, bisphenol A, bisphenol S, bisphenol F and the like are preferable. For example, the bisphenol compound may contain at least one selected from the group consisting of bisphenol A and bisphenol S. By using bisphenol A or bisphenol S, an excellent expanding effect on a negative electrode material can be obtained.

The bisphenol compound may have a bisphenol backbone, and the bisphenol backbone may have a substituent. That is, the bisphenol A may have a bisphenol A backbone, and the backbone may have a substituent. The bisphenol S may have a bisphenol S backbone, and the backbone may have a substituent.

The monocyclic aromatic compound is preferably a hydroxy monoarene compound, a monocyclic aromatic compound having an amino group (aminomonoarene compound), or the like. Among them, a hydroxy monoarene compound is preferable.

Examples of the hydroxy monoarene compound include hydroxy naphthalene compounds and phenol compounds. For example, it is preferable to use a phenol sulfonic acid compound (phenol sulfonic acid or a substituted product thereof) which is a phenol compound. The condensate containing a unit of a phenol sulfonic acid compound has a phenolic hydroxy group and a sulfonic acid group. Both the phenolic hydroxy group and the sulfonic acid group are hydrophilic groups having acidity and strong polarity, the functional groups of which are negatively charged. Accordingly, the condensate containing a unit of a phenol sulfonic acid compound has high adsorptivity to lead and lead sulfate in the negative electrode material. In addition, the condensate is likely to have a planar structure owing to the phenol sulfonic acid, so that the condensate is likely to exist in the vicinity of the carbonaceous material. Thus, when such a condensate is used, a high binding property is easily obtained, so that the effect of suppressing outflow of the carbonaceous material can be further enhanced. Note that as described above, the phenolic hydroxy group also includes a salt of a phenolic hydroxy group (—OMe).

Examples of the aminomonoarene compound include aminonaphthalene compounds and aniline compounds (e.g. aminobenzenesulfonic acid and alkylaminobenzenesulfonic acids).

The organic expanders also include lignin compounds. Herein, the lignin compounds include lignin and lignin derivatives. The lignin derivatives include those having a lignin-like three-dimensional structure. Examples of the lignin derivative include at least one selected from modified lignin, lignin sulfonic acid, modified lignin sulfonic acid, and salts thereof (e.g. alkali metal salts (e.g. sodium salts), magnesium salts, calcium salts).

The sulfur element content of an organic expander other than a lignin compound may be, for example, 2,000 μmol/g or more, or 3,000 μmol/g or more. When an organic expander having such a sulfur element content is used, the colloidal particle size of the organic expander is likely to decrease, and thus the structure of the negative electrode material can be kept fine, so that high low-temperature high-rate (HR) discharge performance is easily secured. When the sulfur element content of a first organic expander as described later is in the above-mentioned range, functional groups containing a sulfur element are likely to be concentrated on the surface of the organic expander in the organic expander to which flexibility is imparted by the unit of a monocyclic aromatic compound having a hydroxy group. Thus, the effect of suppressing outflow of the carbonaceous material can be further enhanced.

The sulfur element content in the organic expander being X μmol/g means that the content of the sulfur element contained per 1 g of the organic expander is X μmol.

The sulfur element content of an organic expander other than a lignin compound is not particularly limited, and may be, for example, 9,000 μmol/g or less, or 8,000 μmol/g or less, or 7,000 μmol/g or less.

The organic expanders other than a lignin compound also include those having a sulfur element content of less than 2,000 μmol/g. The sulfur element content of such an organic expander may be 300 μmol/g or more.

The sulfur element content of the organic expander other than a lignin compound may be, for example, 2,000 μmol/g or more (or 3,000 μmol/g or more) and 9,000 μmol/g or less, 2,000 μmol/g or more (or 3,000 μmol/g or more) and 8,000 μmol/g or less, 2,000 μmol/g or more (or 3,000 μmol/g or more) and 7,000 μmol/g or less, 300 μmol/g or more and 9,000 μmol/g or less (or 8,000 μmol/g or less), or 300 μmol/g or more and 7,000 μmol/g or less (or less than 2,000 μmol/g).

A weight average molecular weight (Mw) of the organic expander other than a lignin compound is preferably, for example, 7,000 or more. The Mw of the organic expander is, for example, 100,000 or less, and may be 20,000 or less.

The elemental sulfur content of the lignin compound is, for example, less than 2,000 μmol/g, and may be 1,000 μmol/g or less or 800 μmol/g or less. The lower limit of the sulfur element content of the lignin compound is not particularly limited, and is, for example, 400 μmol/g or more.

The Mw of the lignin compound is, for example, less than 7,000. The Mw of the lignin compound is, for example, 3,000 or more.

Note that herein, the Mw of the organic expander is determined by gel permeation chromatography (GPC). A standard substance used for determining the Mw is sodium polystyrene sulfonate.

The Mw is measured under the following conditions using the following apparatus.

GPC apparatus: Build-up GPC system SD-8022/DP-8020/AS-8020/CO-8020/UV-8020 (manufactured by Tosoh Corporation)

Column: TSKgel G4000SWXL, G2000SWXL (7.8 mm I.D.×30 cm) (manufactured by Tosoh Corporation)

Detector: UV detector, λ=210 nm

Eluent: Mixed solution of NaCl aqueous solution having a concentration of 1 mol/L:acetonitrile (volume ratio=7:3)

Flow rate: 1 mL/min.

Concentration: 10 mg/mL

Injection amount: 10 μL

Standard substance: Na polystyrene sulfonate (Mw=275,000, 35,000, 12,500, 7,500, 5,200, 1,680)

Examples of the first organic expander among the organic expanders include those containing a unit of a bisarene compound (hereinafter, sometimes referred to as a first unit) and a unit of a monocyclic aromatic compound having a hydroxy group (hereinafter, sometimes referred to as a second unit) (e.g. condensates). Here, the first unit is at least one selected from the group consisting of a unit of a bisphenol S compound and a unit of a bisphenol A compound. The first organic expander may further contain a unit (third unit) of another aromatic compound if necessary.

When the first organic expander contains the first unit, a high expanding effect on the negative electrode material can be secured. In addition, since as opposed to the second unit, the first unit has a structure in which a linking group linking two aromatic rings protrudes from the aromatic ring plane, the first organic expander containing the first unit is unlikely to be adsorbed to lead or lead sulfate. However, even when the first organic expander contains the first unit, the first organic expander is likely to have a planar structure when containing the second unit. In general, the organic expander containing the first unit is likely to be rigid with aromatic rings interacting between n electrons. However, in the first organic expander, the second unit inhibits the interaction between r-electrons of the first unit, so that the flexibility of the molecule can be enhanced. This may ensure that functional groups having negative polarity and contained in the first organic expander are likely to be concentrated on the molecular surface. Accordingly, high adsorptivity of the first organic expander to lead and lead sulfate can be secured, so that outflow of the carbonaceous material can be suppressed.

It is preferable that the first unit contains at least a unit of a bisphenol S compound. The first organic expander may contain a unit of a bisphenol S compound and a unit of a bisphenol A compound as the first unit. The bisphenol S backbone has a structure in which two benzene rings are linked by a sulfonyl group. The bisphenol A backbone has a structure in which two benzene rings are linked by a dimethylene group. The sulfonyl group protrudes from the benzene ring plane to a lesser extent as compared to a dimethylene group. Thus, the unit of a bisphenol S compound ensures that the first organic expander is more likely to have a planar structure as compared to the unit of a bisphenol A compound. In addition, due to the presence of a sulfonyl group, the unit of a bisphenol S compound ensures that the first organic expander is more likely to be negatively charged as compared to the unit of a bisphenol A compound. Accordingly, it is considered that when the first organic expander having at least a unit of a bisphenol S compound is used as the first unit, adsorptivity of the first organic expander to lead and lead sulfate is further enhanced, so that the effect of suppressing outflow of the carbonaceous material can be further improved.

The second unit is preferably a unit of a monocyclic aromatic compound having a phenolic hydroxy group. In a condensate of a monocyclic aromatic compound having a phenolic hydroxy group with an aldehyde compound, the condensation occurs mainly at an ortho position and/or a para position (particularly at an ortho position) with respect to the phenolic hydroxy group. On the other hand, in a condensate of a monocyclic aromatic compound having an amino group with an aldehyde compound, the condensation occurs via the amino group. Thus, it is considered that as compared to use of a monocyclic aromatic compound having an amino group, use of a monocyclic aromatic compound having a phenolic hydroxy group ensures that twist between aromatic rings in the organic expander molecule occurs to a lesser extent, and the organic expander is more likely to have a planar structure, and thus is more easily applied to lead and lead sulfate.

It is preferable that among the units of a monocyclic aromatic compound, first organic expanders containing a unit of a phenol sulfonic acid compound as the second unit are used. Such a first organic expander has a phenolic hydroxy group and a sulfonic acid group. Both the phenolic hydroxy group and the sulfonic acid group have strong negative polarity, and high affinity with a metal. Accordingly, the condensate containing a unit of a phenol sulfonic acid compound as the second unit has higher adsorptivity to lead and lead sulfate. This ensures that the first organic expander is likely to exist in the vicinity of the carbonaceous material in the negative electrode material, and therefore the effect of suppressing outflow of the carbonaceous material can be further enhanced.

The molar ratio of the second unit to the total amount of the first unit and the second unit is, for example, 10 mol % or more, and may be 20 mol % or more. When the molar ratio is in the above-mentioned range, the first organic expander is more likely to have a planar structure. The molar ratio of the second unit is, for example, 90 mol % or less, and may be 80 mol % or less.

The molar ratio of the second unit may be 10 mol % or more (or 20 mol % or more) and 90 mol % or less, or 10 mol % or more (or 20 mol % or more) and 80 mol % or less.

In the first organic expander, the total ratio (molar ratio) of the first unit and the second unit to the total amount of the aromatic compound unit is, for example, 90 mol % or more, and may be 95 mol % or more. The aromatic compound unit may include only the first unit and the second unit.

The sulfur element content and the Mw of the first organic expander can be selected from the above-described ranges, respectively.

One of the first organic expanders may be used alone, or two or more thereof may be used in combination.

Examples of the second organic expander among the above-described organic expanders include condensates containing units of a lignin compound and a bisarene compound (e.g. bisphenol compound) (for example, condensates containing a unit of a bisphenol S compound and a unit of a bisphenol A compound).

One of the second organic expanders may be used alone, or two or more thereof may be used in combination. For example, a second organic expander other than a lignin compound and a lignin compound may be used in combination.

When the first organic expander and the second organic expander are used in combination, the mass ratio thereof can be arbitrarily selected. Even when the second organic expander is used in combination, an effect of suppressing outflow of the carbonaceous material can be obtained depending on a mass ratio of the first organic expander. From the viewpoint of securing a synergistic effect of suppressing outflow of the carbonaceous material, the ratio of the first organic expander to the entire organic expander (i.e. the total amount of the first organic expander and the second organic expander) is preferably 20 mass % or more, and may be 50 mass % or more, or 80 mass % or more.

The content of the organic expander in the negative electrode material is, for example, 1.5 mg or more, and may be 1.7 mg or more, per 1 m² of the surface area of the negative electrode material. From the viewpoint of obtaining a higher effect of suppressing of the carbonaceous material, and easily securing high low-temperature HR discharge performance, the content of the organic expander is preferably more than 1.7 mg, more preferably 1.8 mg or more, or 2 mg or more. The content of the organic expander is, for example, the content of the organic expander is, for example, 3.8 mg or less, and may be 3.7 mg or less. From the viewpoint of easily securing high charge acceptability, the content of the organic expander is preferably less than 3.7 mg, and may be 3.6 mg or less, 3.5 mg or less, or 3.4 mg or less. The content of the first organic expander in the negative electrode material may be in the above-mentioned range.

The content of the organic expander in the negative electrode material is 1.5 mg or more (1.7 mg or more) and 3.8 mg or less, 1.5 mg or more (1.7 mg or more) and 3.7 mg or less, 1.5 mg or more (1.7 mg or more) and less than 3.7 mg, 1.5 mg or more (1.7 mg or more) and 3.6 mg or less, 1.5 mg or more (1.7 mg or more) and 3.5 mg or less, 1.5 mg or more (1.7 mg or more) and 3.4 mg or less, more than 1.7 mg (or 1.8 mg or more) and 3.8 mg or less, more than 1.7 mg (or 1.8 mg or more) and 3.7 mg or less, more than 1.7 mg (or 1.8 mg or more) and less than 3.7 mg, more than 1.7 mg (or 1.8 mg or more) and 3.6 mg or less, more than 1.7 mg (1.8 mg or more) and 3.5 mg or less, more than 1.7 mg (or 1.8 mg or more) and 3.4 mg or less, 2 mg or more and 3.8 mg or less (or 3.7 mg or less), 2 mg or more and less than 3.7 mg (or 3.6 mg or less), or 2 mg or more and 3.5 mg or less (or 3.4 mg or less), per 1 m² of the surface area of the negative electrode material. The content of the first organic expander in the negative electrode material may be in the above-mentioned range.

The surface area of the negative electrode material is obtained by multiplying a mass (g) of the negative electrode material by a BET specific surface area (m²·g⁻¹) determined by a gas adsorption method using nitrogen gas for the negative electrode material.

The surface area of the negative electrode material, the mass of the negative electrode material, and the content of the organic expander in the negative electrode material are determined for a negative electrode plate of a lead-acid battery in a full charge state.

In the present specification, the full charge state of the flooded-type lead-acid battery is defined by the definition of JIS D 5301:2006. More specifically, the following state is defined as a full charge state: the lead-acid battery is charged in a water bath at 25° C.±2° C. at a current (A) 0.2 times as large as a numerical value described as a rated capacity (Ah) until a terminal voltage during charge measured every 15 minutes or an electrolyte solution density subjected to temperature correction to 20° C. exhibits a constant value at three significant digits continuously three times. In the case of a valve regulated lead-acid battery, the full charge state is a state where the lead-acid battery is subjected to constant current constant voltage charge of 2.23 V/cell at a current (A) 0.2 times as large as the numerical value described as the rated capacity (Ah) in an air tank of 25° C.±2° C., and the charge is completed when the charge current (A) during constant voltage charge becomes 0.005 times as large as the numerical value described as the rated capacity. Note that the numerical value described as the rated capacity is a numerical value in which the unit is Ah. The unit of the current set based on the numerical value indicated as the rated capacity is A.

The lead-acid battery in the full charge state refers to a lead-acid battery obtained by fully charging a formed lead-acid battery. The full charge of the lead-acid battery may be performed immediately after formation so long as being performed after formation or may be performed after the lapse of time from formation (e.g., a lead-acid battery in use (preferably at the initial stage of use) after formation may be fully charged). The battery at the initial stage of use refers to a battery that has not been used for a long time and has hardly deteriorated.

### (Carbonaceous Material)

Examples of the carbonaceous material include carbon black, graphite, hard carbon, soft carbon, and the like. Examples of the carbon black include acetylene black, furnace black, and lamp black. Furnace black also includes ketjen black (product name). The graphite may be a carbonaceous material including a graphite-type crystal structure and may be either artificial graphite or natural graphite. One kind of carbonaceous material may be used alone, or two or more kinds thereof may be used in combination.

Among the carbonaceous materials, the carbonaceous material in which an intensity ratio ID/IG of a peak (D band) appearing in a range of 1,300 cm⁻¹ or more and 1,350 cm⁻¹ or less in a Raman spectrum to a peak (G band) appearing in a range of 1,550 cm⁻¹ or more and 1,600 cm⁻¹ or less is 0 or more and 0.9 or less is referred to as graphite. The graphite may be either artificial graphite or natural graphite.

The carbonaceous material may include a first carbonaceous material having a particle size of 32 μm or more, and may include a second carbonaceous material having a particle size of less than 32 μm. The carbonaceous material may include both the first carbonaceous material and the second carbonaceous material. The first carbonaceous material and the second carbonaceous material are separated and distinguished by a procedure described later.

Examples of the first carbonaceous material include at least one selected from the group consisting of graphite, hard carbon, and soft carbon. Among them, the first carbonaceous material preferably contains at least graphite. By using graphite, higher PSOC life performance can be secured. The second carbonaceous material preferably contains at least carbon black.

When the carbonaceous material contains the second carbonaceous material, a ratio of the second carbonaceous material in the whole carbonaceous material is, for example, 10 mass % or more, may be 40 mass % or more, and may be 50 mass % or more or 60 mass % or more. When the ratio of the second carbonaceous material is within such a range, it is advantageous in securing higher charge acceptability. The ratio of the second carbonaceous material in the whole carbonaceous material is, for example, 100 mass % or less. From the viewpoint of easily securing higher low-temperature HR discharge performance, the ratio of the second carbonaceous material may be 90 mass % or less.

The ratio of the second carbonaceous material in the whole carbonaceous material may be 10 mass % or more (or 40 mass % or more) and 100 mass % or less, 10 mass % or more (or 40 mass % or more) and 90 mass % or less, 50 mass % or more (or 60 mass % or more) and 100 mass % or less, or 50 mass % or more (or 60 mass % or more) and 90 mass % or less.

The content of the carbonaceous material in the negative electrode material is, for example, 0.1 mass % or more and may be 0.3 mass % or more. The content of the carbonaceous material is preferably 0.5 mass % or more or 0.9 mass % or more from the viewpoint of easily securing higher charge acceptability. On the other hand, if the content of the carbonaceous material is 0.5 mass % or more or 0.9 mass % or more, outflow of the carbonaceous material becomes marked. In a lead-acid battery according to one aspect of the present invention, outflow of the carbonaceous material can be effectively suppressed by the action of the first organic expander even if the content of the carbonaceous material in the negative electrode material is as high as 0.5 mass % or more or 0.9 mass % or more. The content of the carbonaceous material is, for example, 5 mass % or less and may be 3.5 mass % or less.

The content of the carbonaceous material may be 0.1 mass % or more and 5 mass % or less (or 3.5 mass % or less), 0.3 mass % or more and 5 mass % or less (or 3.5 mass % or less), 0.5 mass % or more and 5 mass % or less (or 3.5 mass % or less), or 0.9 mass % or more and 5 mass % or less (or 3.5 mass % or less).

### (Barium Sulfate)

The negative electrode material can contain barium sulfate. The content of barium sulfate in the negative electrode material is, for example, 0.05 mass % or more and may be 0.10 mass % or more. The content of barium sulfate in the negative electrode material is 3 mass % or less and may be 2 mass % or less.

The content of barium sulfate in the negative electrode material may be 0.05 mass % or more and 3 mass % or less, 0.05 mass % or more and 2 mass % or less, 0.10 mass % or more and 3 mass % or less, or 0.10 mass % or more and 2 mass % or less.

The density of the negative electrode material is, for example, 3.0 g/cm³ or more, and may be 3.2 g/cm³ or more. From the viewpoint of further enhancing the effect of suppressing outflow of the carbonaceous material, the density of the negative electrode material is preferably 3.3 g/cm³ or more. The density of the negative electrode material is, for example, 3.8 g/cm³ or less, and may be 3.7 g/cm³ or less.

The density of the negative electrode material means a value of a bulk density of the negative electrode material in the full charge state.

The density of the negative electrode material may be, for example, 3.0 g/cm³ or more and 3.8 g/cm³ or less (or 3.7 g/cm³ or less), 3.2 g/cm³ or more and 3.8 g/cm³ or less (or 3.7 g/cm³ or less), or 3.3 g/cm³ or more and 3.8 g/cm³ or less (or 3.7 g/cm³ or less).

### (Analysis of Constituent Components of Negative Electrode Material)

Hereinafter, a method of analyzing the negative electrode material or constituent components thereof will be described. Prior to analysis, a lead-acid battery after formation is fully charged and then disassembled to obtain a negative electrode plate to be analyzed. The obtained negative electrode plate is washed with water to remove sulfuric acid from the negative electrode plate. The washing with water is performed until it is confirmed that color of a pH test paper does not change by pressing the pH test paper against the surface of the negative electrode plate washed with water. However, the washing with water is performed within two hours. The negative electrode plate washed with water is dried at 60±5° C. in a reduced pressure environment for about six hours. After drying, when the sticking member is included in the negative electrode plate, the sticking member is removed from the negative electrode plate by peeling. Next, the negative electrode material is separated from the negative electrode plate to obtain a sample (hereinafter, referred to as sample A), and the mass of sample A (M₀) is measured. Sample A is ground as necessary and subjected to analysis.

### (1) Analysis of Organic Expander

### (1-1) Qualitative Analysis of Organic Expander in Negative Electrode Material

Ground sample A is immersed in a 1 mol/L sodium hydroxide (NaOH) aqueous solution to extract the organic expander. Next, if the extract contains a plurality of organic expanders, the organic expanders are separated from the extract. For each separated material containing each organic expander, insoluble components are removed by filtration, and the obtained solution is desalted, then concentrated, and dried. The desalination is performed by using a desalination column, by causing the solution to pass through an ion-exchange membrane, or by placing the solution in a dialysis tube and immersing the solution in distilled water. The solution is dried to obtain a powder sample (hereinafter, also referred to as sample B) of the organic expander.

A type of the organic expander is specified using a combination of information obtained from an infrared spectroscopic spectrum measured using sample B of the organic expander obtained as described above, an ultraviolet-visible absorption spectrum measured by an ultraviolet-visible absorption spectrometer after sample B is diluted with distilled water or the like, an NMR spectrum of a solution obtained by dissolution of sample B with a predetermined solvent such as heavy water, and the like.

When the extract contains a plurality of organic expanders, the organic expanders are separated as follows.

First, the extract is measured by at least one of infrared spectroscopy, NMR and GC-MS to determine whether or not a plurality of types of organic expanders are contained. Next, a molecular weight distribution is measured by GPC analysis of the extract, and if the plurality of types of organic expanders can be separated by molecular weight, the organic expander is separated by column chromatography based on a difference in molecular weight.

The organic expanders are different in solubility if they are different in at least one of the type of functional groups and the amount of functional groups. When it is difficult to separate the organic expanders on the basis of a difference in molecular weight, one of the organic expanders is separated by a precipitation separation method using a difference in solubility as mentioned above. For example, when two organic expanders are contained, an aqueous sulfuric acid solution is added dropwise to a mixture obtained by dissolving the extract in an NaOH aqueous solution to adjust the pH of the mixture, thereby aggregating and separating one of the organic expanders. When separation by aggregation is difficult, the first organic expander is separated by ion exchange chromatography or affinity chromatography using a difference in at least one of the type and the amount of functional groups. The insoluble component is removed by filtration as described above from the separated material dissolved again in the NaOH aqueous solution. The remaining solution after separating one of the organic expanders is concentrated. The obtained concentrate contains the other organic expander, and the insoluble component is removed from the concentrate by filtration as described above.

### (1-2) Quantitative Determination of Content of Organic Expander in Negative Electrode Material

Similarly to (1-1) above, for each separated material containing the organic expander, a solution is obtained after removing the insoluble component by filtration. The ultraviolet-visible absorption spectrum of each obtained solution is measured. The content of each organic expander in the negative electrode material is determined using an intensity of a characteristic peak of each organic expander and a calibration curve prepared in advance.

When a lead-acid battery in which the content of the organic expander is unknown is obtained and the content of the organic expander is measured, a structural formula of the organic expander cannot be strictly specified, so that the same organic expander may not be used for the calibration curve. In this case, the content of the organic expander is measured using the ultraviolet-visible absorption spectrum by creating a calibration curve using the organic expander extracted from the negative electrode of the battery and a separately available organic polymer in which the ultraviolet-visible absorption spectrum, the infrared spectroscopic spectrum, the NMR spectrum, and the like exhibit similar shapes.

### (1-3) Content of Sulfur Element in Organic Expander

Similarly to (1-1) above, after sample B of the organic expander is obtained, sulfur element in 0.1 g of the organic expander is converted into sulfuric acid by an oxygen combustion flask method. At this time, sample B is burned in a flask containing an adsorbent to obtain an eluate in which sulfate ions are dissolved in the adsorbent. Next, the eluate is titrated with barium perchlorate using thorin as an indicator to determine the content (C0) of the sulfur element in 0.1 g of the organic expander. Next, C0 is multiplied by 10 to calculate the content (pmol/g) of the sulfur element in the organic expander per 1 g.

### (2) Analysis of Carbonaceous Material

### (2-1) Separation and Quantitative Determination of Carbonaceous Material

A predetermined amount of ground sample A is taken, and the mass thereof is measured. To sample A, 30 mL of a nitric acid aqueous solution at a concentration of 60 mass % is added per 5 g of sample A, and the mixture is heated at 70° C.±5° C. To the resulting mixture, 10 g of disodium ethylenediaminetetraacetate, 30 mL of ammonia water having a concentration of 28 mass %, and 100 mL of water are added per 5 g of sample A, and heating is continued to dissolve a soluble component. Sample A is pretreated in this manner. The dispersion liquid obtained by the pretreatment is filtered with a membrane filter (opening: 0.1 μm) to collect a solid. The collected sample is passed through a sieve with an opening of 500 μm to remove components having a large size (reinforcing material), and components having passed through the sieve are collected as the carbonaceous materials.

The content of the carbonaceous material (Cc) in the negative electrode material is determined by measuring the mass of each carbonaceous material separated by the above procedure and calculating a ratio (mass %) of a total of the mass to the measured mass of sample A.

When the first carbonaceous material and the second carbonaceous material are separated, the separation is performed by the following procedure.

When the collected carbonaceous material is sieved by a wet method using a sieve with an opening of 32 μm, the carbonaceous material remaining on the sieve without passing through a sieve mesh is defined as the first carbonaceous material, and the carbonaceous material passing through the sieve mesh is defined as the second carbonaceous material. That is, the particle size of each carbonaceous material is based on the size of the mesh opening of the sieve. For wet sieving, JIS Z 8815:1994 can be referred to.

Specifically, the carbonaceous material is placed on a sieve having an opening of 32 μm, and sieved by gently shaking the sieve for 5 minutes while sprinkling ion-exchange water. The first carbonaceous material remaining on the sieve is collected from the sieve by pouring ion-exchange water over the sieve, and separated from the ion-exchange water by filtration. The second carbonaceous material that has passed through the sieve is collected by filtration using a membrane filter (opening: 0.1 μm) made of nitrocellulose. The collected first carbonaceous material and the collected second carbonaceous material are each dried at a temperature of 100° C.±5° C. for 2 hours. As the sieve having an opening of 32 μm, a sieve provided with a sieve mesh having a nominal opening of 32 μm, which is defined in JIS Z 8801-1:2006, is used.

The ratio of the second carbonaceous material in the whole carbonaceous material is determined by calculating a ratio (mass %) of the measured mass of the second carbonaceous material to the mass of the carbonaceous material (total mass of the carbonaceous materials).

### (3) Surface Area of Negative Electrode Material

The surface area of the negative electrode material is determined by multiplying the BET specific surface area of the negative electrode material by the mass of the negative electrode material used in determination of the content of the carbonaceous material (Cc) (i.e. mass (g) of ground sample A measured in (2-1) above).

The BET specific surface area of the negative electrode material is determined using the BET equation by the gas adsorption method using the sample A. Sample A is pretreated by heating at a temperature of 150° C.±5° C. for 1 hour in a nitrogen flow. Using the pretreated sample A, the BET specific surface area is determined by the following apparatus under the following conditions, and defined as a BET specific surface area of the negative electrode material.

Measuring apparatus: TriStar 3000 manufactured by Micromeritics Instrument Corporation.

Adsorption gas: nitrogen gas having a purity of 99.99% or more

Adsorption temperature: liquid nitrogen boiling point temperature (77 K)

Method for calculating BET specific surface area: in accordance with 7.2 of JIS Z 8830:2013

### (4) Quantitative Determination of Barium Sulfate

50 ml of nitric acid having a concentration of 20 mass % is added to 10 g of crushed sample A, and the mixture is heated for about 20 minutes to dissolve a lead component as lead nitrate. Next, a solution containing lead nitrate is filtered, and solids such as carbonaceous materials and barium sulfate are filtered off.

The obtained solid is dispersed in water to prepare a dispersion, and then components except for the carbonaceous material and barium sulfate (e.g., reinforcing material) are removed from the dispersion by using a sieve. Next, the dispersion is subjected to suction filtration using a membrane filter with its mass measured in advance, and the membrane filter is dried with the filtered sample in a dryer at 110° C.±5° C. The obtained sample is a mixed sample of carbonaceous material and barium sulfate (hereinafter also referred to as sample C). A mass of sample C is measured by subtracting the mass of the membrane filter from the total mass of dried sample C and the membrane filter. Thereafter, dried sample C is placed in a crucible together with a membrane filter and is burned and incinerated at 700° C. or higher. The residue remaining is barium oxide. The mass of barium sulfate is determined by converting the mass of barium oxide to the mass of barium sulfate.

### (Measurement of Density of Negative Electrode Material)

The density of the negative electrode material is measured as follows.

A predetermined amount of sample A is taken, and the mass thereof is measured. The sample A is charged into a measurement container, evacuated under reduced pressure, and then filled with mercury at a pressure of 0.5 psia or more and 0.55 psia or less (˜ 3.45 kPa or more and 3.79 kPa or less) to measure a bulk volume of sample A and the measured mass of sample A is divided by the bulk volume to determine the bulk density of the negative electrode material. A volume obtained by subtracting a mercury injection volume from a volume of the measurement container is defined as the bulk volume.

For the measurement of the density of the negative electrode material, an automatic porosimeter (AutoPore IV 9505) manufactured by Shimadzu Corporation is used.

### (Others)

The negative electrode plate can be formed in such a manner that a negative current collector is coated or filled with a negative electrode paste, which is then cured and dried to prepare a non-formed negative electrode plate, and thereafter, the non-formed negative electrode plate is formed. The negative electrode paste is prepared by adding water and sulfuric acid to lead powder and an organic expander, and various additives as necessary, and kneading the mixture. At the time of curing, it is preferable to cure the non-formed negative electrode plate at a higher temperature than room temperature and high humidity.

The formation can be performed by charging the element in a state where the element including the non-formed negative electrode plate immersed in the electrolyte solution containing sulfuric acid in the container of the lead-acid battery. However, the formation may be performed before the lead-acid battery or the element is assembled. The formation produces spongy lead.

### (Positive Electrode Plate)

The positive electrode plate of the lead-acid battery typically includes a positive current collector and a positive electrode material. The positive electrode material is held by the positive current collector. The positive electrode plate of a lead-acid battery can be classified into a paste type, a clad type, and the like. Either a paste-type or a clad-type positive electrode plate may be used.

The positive current collector may be formed by casting lead (Pb) or a lead alloy, or may be formed by processing a lead sheet or a lead alloy sheet. Examples of the processing method include expanding processing or punching processing. It is preferable to use a grid-like current collector as the positive current collector because the positive electrode material is easily supported.

As a lead alloy used for the positive current collector, a Pb—Sb alloy, a Pb—Ca alloy, or a Pb—Ca—Sn alloy are preferred in terms of corrosion resistance and mechanical strength. The positive current collector may include a surface layer. The surface layer and the inner layer of the positive current collector may have different compositions. The surface layer may be formed in a part of the positive current collector. The surface layer may be formed only on the grid portion, only on the lug portion, or only on the frame rib portion of the positive current collector.

In the paste-type positive electrode plate, the positive electrode material is a portion obtained by removing the positive current collector from the positive electrode plate. A member such as a mat or a pasting paper may be stuck to the positive electrode plate. Such a member (sticking member) is used integrally with the positive electrode plate and is thus assumed to be included in the positive electrode plate. In addition, when the positive electrode plate includes a sticking member (e.g. mat or pasting paper), the positive electrode material is a portion obtained by removing the positive current collector and the sticking member from the positive electrode plate in the case of a paste-type positive electrode plate.

The positive electrode material contained in the positive electrode plate contains a positive active material (lead dioxide or lead sulfate) that exhibits a capacity through a redox reaction. The positive electrode material may optionally contain another additive.

A non-formed paste-type positive electrode plate is obtained by filling a positive current collector with a positive electrode paste, and curing and drying the paste. The positive electrode paste is prepared by kneading lead powder, an additive, water, and sulfuric acid.

The positive electrode plate is obtained by forming the non-formed positive electrode plate. The formation can be performed by charging the element in a state where the element including the non-formed positive electrode plate immersed in the electrolyte solution containing sulfuric acid in the container of the lead-acid battery. However, the formation may be performed before the lead-acid battery or the element is assembled.

### (Separator)

The separator can be disposed between the negative electrode plate and the positive electrode plate. As the separator, for example, at least one selected from a nonwoven fabric and a microporous membrane is used. The thickness of separators interposed between the negative electrode plate and the positive electrode plate may be selected in accordance with the distance between the electrodes. The number of separators only needs to be selected in accordance with the number of poles.

The nonwoven fabric is a mat in which fibers are intertwined without being woven and is mainly made of fibers. In the nonwoven fabric, for example, 60 mass % or more of the nonwoven fabric is formed of fibers. As the fibers, there can be used glass fibers, polymer fibers (polyolefin fiber, acrylic fiber, polyester fiber (polyethylene terephthalate fiber, etc.), etc.), pulp fibers, and the like. Among them, glass fibers are preferable. The nonwoven fabric may contain components in addition to the fibers (e.g. acid-resistant inorganic powder, and a polymer as a binder).

On the other hand, the microporous film is a porous sheet mainly made of components except for fiber components and is obtained by, for example, extrusion molding a composition containing, for example, a pore-forming additive (at least one of polymer powder and oil) into a sheet shape and then removing the pore-forming additive to form pores. The microporous film is preferably composed of a material having acid resistance and is preferably composed mainly of a polymer component. As the polymer material, a polyolefin (polyethylene, polypropylene, etc.) is preferred.

The separator may be, for example, composed of only a nonwoven fabric or composed of only a microporous film. The separator may be, when required, a laminate of a nonwoven fabric and a microporous film, a laminate of different or the same kind of materials, or a laminate of different or the same kind of materials in which recesses and projections are engaged to each other.

The separator may have a sheet shape or may be formed in a bag shape. One sheet-like separator may be disposed between the positive electrode plate and the negative electrode plate. Further, the electrode plate may be disposed so as to be sandwiched by one sheet-like separator in a folded state. In this case, the positive electrode plate sandwiched by the folded sheet-like separator and the negative electrode plate sandwiched by the folded sheet-like separator may be overlapped, or one of the positive electrode plate and the negative electrode plate may be sandwiched by the folded sheet-like separator and overlapped with the other electrode plate. Also, the sheet-like separator may be folded into a bellows shape, and the positive electrode plate and the negative electrode plate may be sandwiched by the bellows-shaped separator such that the separator is interposed therebetween. When the separator folded in a bellows shape is used, the separator may be disposed such that the folded portion is along the horizontal direction of the lead-acid battery (e.g., such that the bent portion may be parallel to the horizontal direction), and the separator may be disposed such that the folded portion is along the vertical direction (e.g., such that the bent portion is parallel to the vertical direction). In the separator folded in the bellows shape, recesses are alternately formed on both main surface sides of the separator. Since the lugs are usually formed on the upper portion of the positive electrode plate and the negative electrode plate, when the separator is disposed such that the folded portions are along the horizontal direction of the lead-acid battery, the positive electrode plate and the negative electrode plate are each disposed only in the recess on one main surface side of the separator (i.e., a double separator is interposed between the adjacent positive and negative plates). When the separator is disposed such that the folded portion is along the vertical direction of the lead-acid battery, the positive electrode plate can be housed in the recess on one main surface side, and the negative electrode plate can be housed in the recess on the other main surface side (i.e., the separator can be interposed singly between the adjacent positive and negative plates). When the bag-shaped separator is used, the bag-shaped separator may house the positive electrode plate or may house the negative electrode plate.

Note that, herein, in the plate, the up-down direction is defined with a side on which a lug is provided as an upper side and a side opposite to the lug as a lower side. The up-down direction of the plate may be identical to or different from the up-down direction of the lead-acid battery in the vertical direction. That is, the lead-acid battery may be either vertical or horizontal.

### (Electrolyte Solution)

The electrolyte solution is an aqueous solution containing sulfuric acid and may be gelled as necessary. The electrolyte solution may contain at least one selected from the group consisting of cations (for example, metal cations) and anions (for example, anions other than sulfate anions (such as phosphate ions)) if necessary. Examples of the metal cation include at least one selected from the group consisting of a sodium ion, a lithium ion, a magnesium ion, and an aluminum ion.

The specific gravity of the electrolyte solution in the lead-acid battery in the full charge state at 20° C. is, for example, 1.20 or more and may be 1.25 or more. The specific gravity of the electrolyte solution at 20° C. is 1.35 or less and preferably 1.32 or less.

The specific gravity of the electrolyte solution in a lead-acid battery in a full charge state at 20° C. may be 1.20 or more and 1.35 or less, 1.20 or more and 1.32 or less, 1.25 or more and 1.35 or less, or 1.25 or more and 1.32 or less.

The lead-acid battery can be obtained by a production method including a step of assembling a lead-acid battery by housing a positive electrode plate, a negative electrode plate, and an electrolyte solution in a container. In the assembly process of the lead-acid battery, the separator is usually disposed so as to be interposed between the positive electrode plate and the negative electrode plate. The assembly process of the lead-acid battery may include a step of forming at least one of the positive electrode plate and the negative electrode plate as necessary after the step of housing the positive electrode plate, the negative electrode plate, and the electrolyte solution in the container. The positive electrode plate, the negative electrode plate, the electrolyte solution, and the separator are each prepared before being housed in the container.

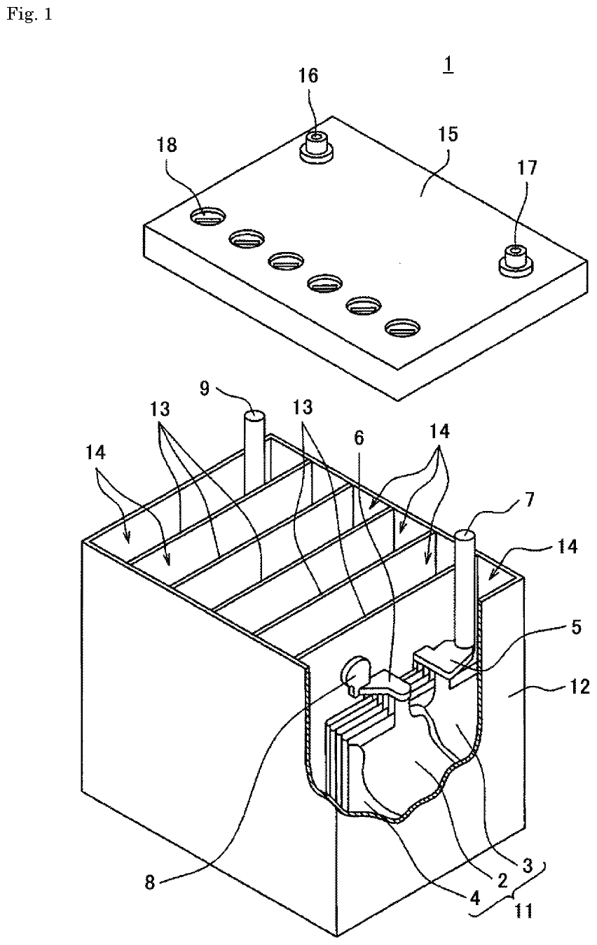

FIG. 1 shows an appearance of an example of a lead-acid battery according to an embodiment of the present invention.

A lead-acid battery 1 includes a container 12 that houses an element 11 and an electrolyte solution (not shown). The inside of the container 12 is partitioned by partitions 13 into a plurality of cell chambers 14. Each of the cell chambers 14 contains one element 11. An opening of the container 12 is closed with a lid 15 having a negative electrode terminal 16 and a positive electrode terminal 17. The lid 15 is provided with a vent plug 18 for each cell chamber. At the time of water addition, the vent plug 18 is removed to supply a water addition liquid. The vent plug 18 may have a function of discharging gas generated in the cell chamber 14 to the outside of the battery.

The element 11 is configured by laminating a plurality of negative electrode plates 2 and positive electrode plates 3 with a separator 4 interposed therebetween. Here, the bag-shaped separator 4 housing the negative electrode plate 2 is shown, but the form of the separator is not particularly limited. In the cell chamber 14 located at one end of the container 12, a negative electrode shelf portion 6 for connecting the plurality of negative electrode plates 2 in parallel is connected to a penetrating connection body 8, and a positive electrode shelf portion 5 for connecting the plurality of positive electrode plates 3 in parallel is connected to a positive pole 7. The positive pole 7 is connected to the positive electrode terminal 17 outside the lid 15. In the cell chamber 14 located at the other end of the container 12, a negative pole 9 is connected to the negative electrode shelf portion 6, and the penetrating connection body 8 is connected to the positive electrode shelf portion 5. The negative pole 9 is connected to the negative electrode terminal 16 outside the lid 15. Each of the penetrating connection bodies 8 passes through a through-hole provided in the partition 13 to connect the elements 11 of the adjacent cell chambers 14 in series.

The positive electrode shelf portion 5 is formed by welding the lugs, provided on the upper portions of the respective positive electrode plates 3, to each other by a cast-on-strap method or a burning method. The negative electrode shelf portion 6 is also formed by welding the lugs, provided on the upper portions of the respective negative electrode plates 2, to each other in accordance with the case of the positive electrode shelf portion 5.

The lid 15 of the lead-acid battery has a single structure (single lid), but is not limited to the illustrated examples. The lid 15 may have, for example, a double structure including an inner lid and an outer lid (or an upper lid). The lid having the double structure may have a reflux structure between the inner lid and the outer lid for returning the electrolyte solution into the battery (inside the inner lid) through a reflux port provided in the inner lid.

Outflow of the carbonaceous material to the electrolyte solution in the lead-acid battery is evaluated as follows.

For one cell of the lead-acid battery after full charge, all the electrolyte solution is taken out, and the carbonaceous material contained in the electrolyte solution is collected by filtration. Here, the carbon material deposited on the separator is washed with water and collected by filtration together with the carbonaceous material contained in the electrolyte solution. The collected carbonaceous material is washed with water and dried, and the mass (mₑ) of the dried carbonaceous material is measured. The carbonaceous material content Cc (mass %) determined by the above-described procedure is multiplied by the mass M₀ of the sample A and the resulting product is divided by 100 to determine the mass mₙ of the carbonaceous material in the negative electrode material. The mass mₑ of the carbonaceous material in the electrolyte solution is divided by the mass mₙ of the carbonaceous material to determine the ratio mₑ/mₙ. Outflow of the carbonaceous material to the electrolyte solution is evaluated on the basis of the mₑ/mₙ ratio. Outflow of the carbonaceous material decreases as the mₑ/mₙ ratio decreases.

The mₑ/mₙ ratio is, for example, 5.0×10⁻² or less, and may be 3.0×10⁻² or less or 2.0×10⁻² or less. By using the first organic expander, outflow of the carbonaceous material to the electrolyte solution can be suppressed to the above-mentioned mₑ/mₙ ratio.

The negative electrode plate for a lead-acid battery and the lead-acid battery according to one aspect of the present invention will be described below.

(1) A lead-acid battery including a positive electrode plate, a negative electrode plate and an electrolyte solution, in which

the negative electrode plate contains a negative electrode material,

the negative electrode material contains an organic expander (first organic expander) and a carbonaceous material,

the organic expander (first organic expander) contains a unit of a bisarene compound (first unit) and a unit of a monocyclic aromatic compound (second unit) having a hydroxy group, and

the unit of a bisarene compound is at least one selected from the group consisting of a unit of a bisphenol S compound and a unit of a bisphenol A compound.

(2) In (1) above, the sulfur element content of the first organic expander may be 300 μmol/g or more, 2,000 μmol/g or more, or 3,000 μmol/g or more.

(3) In (1) or (2) above, the sulfur element content of the first organic expander may be 9,000 μmol/g or less, 8,000 μmol/g or less, or 7,000 μmol/g or less.

(4) In any one of (1) to (3) above, a weight average molecular weight (Mw) of the first organic expander may be, for example, 7,000 or more.

(5) In (1) or (2) above, the sulfur element content of the first organic expander may be less than 2,000 μmol/g.

(6) In (5) above, the sulfur element content of the first organic expander may be 300 μmol/g or more.

(7) In any one of (1) to (6) above, the weight average molecular weight (Mw) of the first organic expander may be 100,000 or less, or 20,000 or less.

(8) In any one of (1) to (7) above, the unit of a bisarene compound (first unit) may contain at least a unit of a bisphenol S compound.

(9) In any one of (1) to (8) above, the unit of a monocyclic aromatic compound having a hydroxy group (second unit) may be a unit of a phenol sulfonic acid compound.

(10) In any one of (1) to (9) above, a molar ratio of the second unit to a total amount of the first unit and the second unit may be 10 mol % or more, or 20 mol % or more.

(11) In any one of (1) to (10) above, a molar ratio of the second unit to a total amount of the first unit and the second unit may be 90 mol % or less, or 80 mol % or less.

(12) In any one of (1) to (11) above, a total ratio (molar ratio) of the first unit and the second unit to a total amount of aromatic compound units contained in the first organic expander may be 90 mol % or more, or 95 mol % or more.

(13) In any one of (1) to (12) above, a ratio of the first organic expander to the entire organic expander contained in the negative electrode material may be 20 mass % or more, 50 mass % or more, or 80 mass % or more.

(14) In any one of the (1) to (13) above, a content of the organic expander (or first organic expander) contained in the negative electrode material may be 1.5 mg or more, 1.7 mg or more, more than 1.7 mg, 1.8 mg or more, or 2 mg or more, per 1 m² of the surface area of the negative electrode material.

(15) In any one of (1) to (14) above, a content of the organic expander (or first organic expander) contained in the negative electrode material may be 3.8 mg or less, 3.7 mg or less, less than 3.7 mg, 3.6 mg or less, 3.5 mg or less, or 3.4 mg or less, per 1 m² of the surface area of the negative electrode material.

(16) In any one of (1) to (15) above, the carbonaceous material may include at least one of a first carbonaceous having a particle size of 32 μm or more and a second carbonaceous material having a particle size of less than 32 μm.

(17) In (16) above, a ratio of the second carbonaceous material in the whole carbonaceous material may be 10 mass % or more, 40 mass % or more, 50 mass % or more, or 60 mass % or more.

(18) In (16) or (17) above, the ratio of the second carbonaceous material in the whole carbonaceous material may be 100 mass % or less or 90 mass % or less.

(19) In any one of (1) to (18) above, a content of the carbonaceous material in the negative electrode material may be 0.1 mass % or more, 0.3 mass % or more, 0.5 mass % or more, or 0.9 mass % or more.

(20) In any one of (1) or (19) above, the content of the carbonaceous material in the negative electrode material may be 5 mass % or less, or 3.5 mass % or less.

(21) In any one of (1) to (20) above, the negative electrode material may contain barium sulfate.

(22) In (21) above, the content of the barium sulfate in the negative electrode material may be 0.05 mass % or more or 0.10 mass % or more.

(23) In (21) or (22) above, the content of the barium sulfate in the negative electrode material may be 3 mass % or less or 2 mass % or less.

(24) In any one of (1) to (23) above, a density of the negative electrode material may be 3.0 g/cm³ or more, 3.2 g/cm³ or more, or 3.3 g/cm³ or more.

(25) In any one of (1) to (24) above, a density of the negative electrode material may be 3.8 g/cm³ or less, or 3.7 g/cm³ or less.

(26) In any one of (1) to (25) above, a specific gravity of the electrolyte solution in the lead-acid battery in a full charge state at 20° C. may be 1.20 or more, or 1.25 or more.

(27) In any one of (1) to (26) above, the specific gravity of the electrolyte solution in the lead-acid battery in a full charge state at 20° C. may be 1.35 or less, or 1.32 or less.

### Example

Hereinafter, the present invention will be specifically described on the basis of examples and comparative examples, but the present invention is not limited to the following examples.

### <<Lead-Acid Batteries E1 to E10 and R1 to R6>>

### (1) Preparation of Lead-Acid Battery

### (a) Preparation of Negative Electrode Plate

Lead powder as raw material, barium sulfate, a second carbonaceous material (acetylene black), an organic expander and an appropriate amount of a sulfuric acid aqueous solution are mixed to obtain a negative electrode paste. Here, the components are mixed in such a manner that the content of the organic expander and the content of carbonaceous material in the negative electrode material, which are determined by the procedures described above, are the values shown in Table 1. In addition, for the lead-acid battery fully charged after formation, the concentration and the amount of the sulfuric acid aqueous solution are adjusted so that the density of the negative electrode material, which is determined by the procedure described above, is the value shown in Table 1.

A mesh portion of an expanded grid made of a Pb—Ca—Sn alloy is filled with the negative electrode paste, which is then cured and dried to obtain a non-formed negative electrode plate.

As the organic expander, those shown in Table 1 are used. The organic expanders shown in Table 1 are as follows.

e1 (first organic expander): Condensate of bisphenol S and phenol sulfonic acid (2:8 (molar ratio)) with formaldehyde (sulfur element content: 5,000 μmol/g, Mw=8,000)

e2 (first organic expander): Condensate of bisphenol S and phenol sulfonic acid (8:2 (molar ratio)) with formaldehyde (sulfur element content: 4,000 μmol/g, Mw=8,000)

e3 (first organic expander): Condensate of bisphenol A and phenol sulfonic acid (8:2 (molar ratio)) with formaldehyde (sulfur element content: 900 μmol/g, Mw=8,000)

e4 (second organic expander): sodium lignin sulfonate (sulfur element content: 600 μmol/g, Mw=5,500)

e5 (second organic expander): Condensate obtained by condensing bisphenol S and formaldehyde in the presence of sodium sulfite (sulfur element content: 5,000 μmol/g, Mw=8,000)

### (b) Preparation of Positive Electrode Plate

Lead powder as raw material is mixed with a sulfuric acid aqueous solution to obtain a positive electrode paste. A mesh portion of an expanded grid made of a Pb—Ca—Sn alloy is filled with the positive electrode paste, which is then cured and dried to obtain a non-formed positive electrode plate.

### (c) Preparation of Test Battery

The negative electrode plate is housed in a bag-shaped separator formed of a polyethylene microporous film. One negative electrode plate is sandwiched between two positive electrode plates to form an element.

The element is housed into a container made of polypropylene together with an electrolyte solution to assemble a lead-acid battery. The assembled battery is subjected to formation to complete a flooded-type lead-acid battery. The power of the lead-acid battery is 2 V, and the rated 5-hour rate capacity is 5 Ah The specific gravity of the electrolyte solution after formation is 1.28. The negative electrode material after the formation contains barium sulfate at 0.5 mass %.

### (2) Evaluation

### (a) Outflow of Carbonaceous Material to Electrolyte Solution

For the lead-acid battery after full charge, outflow of the carbonaceous material to the electrolyte solution is evaluated on the basis of the mₑ/mₙ ratio.

### (b) Low-Temperature HR Discharge Performance

The lead-acid battery after full charge is discharged at a discharge current (A), which is five times the value described as a rated capacity (Ah), at −15° C.±0.3° C. until the terminal voltage reaches 1 V/cell, and a discharge time (discharge duration time) (s) at this time is obtained. The low-temperature HR discharge performance is evaluated by a ratio of a discharge duration time to the discharge duration time of the lead-acid battery R1, which is defined as 100. The longer the discharge duration time, the better the low-temperature HR discharge performance.

### (c) Charge Acceptability

Under the following conditions, the lead-acid battery after full charge is discharged to a depth of discharge (DOD) of 10%, and the lead-acid battery after discharge is charged. For the charge acceptability, the amount of electricity for 10 seconds after the start of charge is determined. The charge acceptability of each lead-acid battery is evaluated by a ratio to the amount of electricity of the lead-acid battery R1, which is defined as 100.

Discharge (DOD adjustment): Current value (A) which is 0.2 times the value described as rated capacity (Ah), 30 minutes

Pause: 24 hours

Charge (charge acceptability): Constant voltage (2.4 V/cell, maximum current: 16.67 A), 10 seconds

Temperature: 25° C.±0.3° C.

Table 1 shows the results.

TABLE 1

| | Carbonaceous | | Organic | Organic | Negative | | Low-temperature | |
|---|---|---|---|---|---|---|---|---|
| | material | | expander | expander | electrode | mₑ/mₙ | HR discharge | Charge |
| | content | Organic | content | content | material density | ratio | performance | acceptability |
| | (mass %) | expander | (mass %) | (mg/m²) | (g/cm³) | (×10⁻²) | (%) | (%) |
| E1 | 0.3 | e2 | 0.20 | 2.9 | 3.7 | 0.2 | 144 | 103 |
| E2 | 0.5 | e2 | 0.20 | 2.4 | 3.7 | 0.8 | 142 | 110 |
| E3 | 0.9 | e1 | 0.30 | 2.7 | 3.7 | 1.1 | 140 | 112 |
| E4 | 1.5 | e1 | 0.30 | 2.0 | 3.6 | 1.5 | 135 | 117 |
| E5 | 1.5 | e1 | 0.30 | 2.0 | 3.3 | 1.8 | 134 | 113 |
| E6 | 1.5 | e1 | 0.55 | 3.7 | 3.3 | 1.2 | 144 | 106 |
| E7 | 1.5 | e1 | 0.25 | 1.7 | 3.3 | 1.9 | 124 | 118 |
| E8 | 1.5 | e1 | 0.30 | 2.0 | 3.2 | 2 | 130 | 111 |
| E9 | 1.5 | e2 | 0.50 | 3.4 | 3.6 | 1.3 | 140 | 113 |
| E10 | 1.5 | e3 | 0.50 | 3.4 | 3.6 | 1.6 | 125 | 110 |
| R1 | 0.3 | e4 | 0.20 | 2.9 | 3.5 | 0.3 | 100 | 100 |
| R2 | 0.5 | e4 | 0.20 | 2.4 | 3.5 | 1.8 | 90 | 105 |
| R3 | 0.9 | e4 | 0.15 | 1.4 | 3.4 | 3.1 | 80 | 107 |
| R4 | 1.5 | e4 | 0.15 | 1.0 | 3.4 | 6.5 | 73 | 110 |
| R5 | 2.1 | e4 | 0.15 | 0.8 | 3.4 | 8.5 | 70 | 113 |
| R6 | 1.5 | e4 | 0.20 | 4.7 | 3.4 | 2.1 | — | — |
| | | e5 | 0.50 | | | | | |

As shown in Table 1, use of the first organic expander as the organic expander suppresses outflow of the carbonaceous material as compared to use of only the second organic expander as the organic expander (comparison of lead-acid batteries E1 to E3 with lead-acid batteries R1 to R3, and comparison of lead-acid batteries E4 to E10 with lead-acid batteries R4 and R6). In the case of the second organic expander, the effect of suppressing outflow of the carbonaceous material is low even when the content thereof in the negative electrode material increases (comparison of lead-acid batteries E4 to E10 with lead-acid battery R6).

In addition, when the content of the carbonaceous material in the negative electrode material is 0.5 mass % or more (particularly 0.9 mass % or more), the effect of suppressing outflow of the carbonaceous material by using the first organic expander is more markedly exhibited as compared to a case where the content of the carbonaceous material in the negative electrode material is less than 0.5 mass % (or less than 0.9 mass %).

From the viewpoint of securing higher low-temperature HR discharge performance, the content of the organic expander is preferably more than 1.7 mg (e.g. 1.8 mg or more), more preferably 2.0 mg or more, per 1 m² of the surface area of the negative electrode material. From the viewpoint of securing higher charge acceptability, the content of the organic expander is preferably less than 3.7 mg (e.g. 3.5 mg or less), more preferably 3.4 mg or less, per 1 m² of the surface area of the negative electrode material.

From the viewpoint of further enhancing the effect of suppressing outflow of the carbonaceous material, the density of the negative electrode material is preferably 3.3 g/cm³ or less.

### <<Lead-Acid Batteries E11 and E12>>

The carbonaceous materials shown in Table 2 are used instead of acetylene black (CB). A negative electrode pastes is prepared by mixing the components in such a manner that the content of the carbonaceous material and the content of the organic expander, which are determined by the procedure described above, are the values shown in Table 2. At this time, for the lead-acid battery fully charged after formation, the concentration and amount of the sulfuric acid aqueous solution are controlled so that the density of the negative electrode material determined by the procedure described above is the value shown in Table 2. In the same manner as in the case of the lead-acid battery E4 except for the above, lead-acid batteries E11 and E12 are prepared, and evaluated.

In Table 2, FG is artificial graphite. Table 2 shows the results. The results for the lead-acid battery E4 are also shown in Table 2.

TABLE 2

| | Carbonaceous | | Organic | Organic | Negative | | Low-temperature | |
|---|---|---|---|---|---|---|---|---|
| | material | | expander | expander | electrode | mₑ/mₙ | HR discharge | Charge |
| | content | Organic | content | content | material density | ratio | performance | acceptability |
| | (mass %) | expander | (mass %) | (mg/m²) | (g/cm³) | (×10⁻²) | (%) | (%) |
| E4 | CB | e1 | 0.30 | 2.0 | 3.6 | 1.5 | 135 | 117 |
| | 1.5 | | | | | | | |
| E11 | CB + FG | | 0.30 | 2.2 | 3.4 | 0.8 | 137 | 120 |
| | 1.0 + 1.0 | | | | | | | |
| E12 | FG | | 0.20 | 2.5 | 3.5 | 0.3 | 145 | 115 |
| | 1.5 | | | | | | | |
| R1 | 0.3 | e4 | 0.20 | 2.9 | 3.5 | 0.3 | 100 | 100 |

As shown in Table 2, the amount of outflow of the carbonaceous material can be suppressed even when artificial graphite (first carbonaceous material) is used as the carbonaceous material. From the viewpoint of securing higher low-temperature HR discharge performance, it is preferable to use the first carbonaceous material. In addition, from the viewpoint of securing higher charge acceptability, it is preferable to use carbon black (second carbonaceous material).

### INDUSTRIAL APPLICABILITY

The lead-acid battery according to one aspect of the present invention can be suitably used as, for example, a power source for starting a vehicle (automobiles, motorcycles, etc.) and a power source for an industrial energy storage apparatus (such as an electric vehicle (e.g. forklift)). Note that these applications are merely illustrative and not limited to these applications.

### DESCRIPTION OF REFERENCE SIGNS

1: lead-acid battery
2: negative electrode plate
3: positive electrode plate
4: separator
5: positive electrode shelf portion
6: negative electrode shelf portion
7: positive pole
8: penetrating connection body
9: negative pole
11: element
12: container
13: partition
14: cell chamber
15: lid
16: negative electrode terminal
17: positive electrode terminal
18: vent plug

1. A lead-acid battery comprising a positive electrode plate, a negative electrode plate and an electrolyte solution, wherein
the negative electrode plate contains a negative electrode material,
the negative electrode material contains an organic expander and a carbonaceous material,
the organic expander includes a first organic expander,
the first organic expander contains a unit of a bisarene compound and a unit of a monocyclic aromatic compound having a hydroxy group, and
the unit of a bisarene compound is at least one selected from the group consisting of a unit of a bisphenol S compound and a unit of a bisphenol A compound.

2. The lead-acid battery according to claim 1, wherein a content of the carbonaceous material in the negative electrode material is 0.5 mass % or more.

3. The lead-acid battery according to claim 1, wherein the content of the carbonaceous material in the negative electrode material is 0.9 mass % or more.

4. The lead-acid battery according to claim 1, wherein a content of the organic expander in the negative electrode material is 1.8 mg or more per 1 m² of a surface area of the negative electrode material.

5. The lead-acid battery according to claim 1, wherein the content of the organic expander in the negative electrode material is 3.6 mg or less per 1 m² of a surface area of the negative electrode material.

6. The lead-acid battery according to claim 1, wherein the content of the organic expander in the negative electrode material is 1.5 ng or more and 3.8 mg or less per 1 m² of a surface area of the negative electrode material.

7. The lead-acid battery according to claim 1, wherein a density of the negative electrode material is 3.3 g/cm³ or more.

8. The lead-acid battery according to claim 1, wherein the unit of a bisarene compound contains at least the unit of a bisphenol S compound.

9. The lead-acid battery according to claim 1, wherein the unit of a monocyclic aromatic compound having a hydroxy group is a unit of a phenol sulfonic acid compound.

10. The lead-acid battery according to claim 1, wherein a sulfur element content of the first organic expander is 300 μmol/g or more and 9,000 μmol/g or less.

11. The lead-acid battery according to claim 1, wherein a sulfur element content of the first organic expander is 300 μmol/g or more and less than 2,000 μmol/g.

12. The lead-acid battery according to claim 1, wherein a sulfur element content of the first organic expander is 3,000 μmol/g or more.

13. The lead-acid battery according to claim 1, wherein a weight average molecular weight (Mw) of the first organic expander is 7,000 or more and 100,000 or less.

14. The lead-acid battery according to claim 1, wherein the first organic expander contains a first unit which is a unit of a bisarene compound, and a second unit which is a unit of a monocyclic aromatic compound having a hydroxy group, and
a molar ratio of the second unit to a total amount of the first unit and the second unit is 10 mol % or more and 90 mol % or less.

15. The lead-acid battery according to claim 14, wherein a total ratio (molar ratio) of the first unit and the second unit to the total amount of aromatic compound units contained in the first organic expander is 90 mol % or more.

16. The lead-acid battery according to claim 1, wherein a ratio of the first organic expander to the entire organic expander contained in the negative electrode material is 20 mass % or more.

17. The lead-acid battery according to claim 1, wherein the carbonaceous material includes at least one of a first carbonaceous having a particle size of 32 μm or more and a second carbonaceous material having a particle size of less than 32 μm, and
a ratio of the second carbonaceous material to the entire carbonaceous material is 10 mass % or more and 100 mass % or less.

18. The lead-acid battery according to claim 1, wherein the content of the carbonaceous material in the negative electrode material is 0.1 mass % or more and 5 mass % or less.

19. The lead-acid battery according to claim 1, wherein the negative electrode material contains barium sulfate, and a content of the barium sulfate is 0.05 mass % or more and 3 mass % or less.

20. The lead-acid battery according to claim 1, wherein a density of the negative electrode material is 3.8 g/cm³ or less.
